(19) United States
(12) Patent Application Publication
(10) Pub. No.: US 2023/0110838 A1
(43) Pub. Date: Apr. 13, 2023

(54) Efficient Solar Powered Removal of Volatile Components from Slurries

(71) Applicant: D&D Manufacturing, LLC, Rockledge, FL (US)

(72) Inventor: Dale E. Polk, JR., Titusville, FL (US)

(21) Appl. No.: 18/064,254

(22) Filed: Dec. 10, 2022

Related U.S. Application Data
(63) Continuation-in-part of application No. 17/174,413, filed on Feb. 12, 2021.

(51) Int. Cl. F26B 3/28; F24S 23/74; F24S 20/30; F26B 17/00; F26B 17/18

(52) U.S. Cl. CPC F26B 3/28; F24S 23/74; F24S 20/30; F26B 17/008; F26B 17/18; F24S 2023/88

(57) ABSTRACT

A system and method for the removal of volatile components from a liquid or a slurry containing solids and liquids and using a screw conveyor or auger systems that transfers solid/liquid slurries through an elongated tube heated by solar energy from a parabolic solar trough. The system flashes off the volatile component then counter-currently flows that vapor back into the hollow pipe inside of the augur creating a Multi-effect or Multi Flash device which greatly improves the overall efficiency of removal of the volatile material.

### CROSS-REFERENCE TO RELATED APPLICATIONS

This application is a Continuation-in-Part of U.S. application Ser. No. 17/174,413 filed Feb. 12, 2021. The aforementioned application is hereby incorporated by reference in its entirety into the present application to the extent consistent with the present application.

### FIELD

This disclosure relates to the removal of volatile components from a liquid or a slurry containing solids and liquids and using a screw conveyor or auger system that transfers solid/liquid slurries through a tube heated by solar energy from a parabolic solar trough. The system flashes off the volatile component then counter-currently flows that vapor back into the augur creating a Multi-effect or Multi Flash device which greatly improves the overall efficiency of removal of the volatile material.

### BACKGROUND

There are numerous industrial operations that introduce volatiles into their operations and then require that those volatiles be removed later. Well known applications are mines or quarries that introduce water and later require that the moisture be removed. Dewatering is a process that separates liquid-solid mixtures, such as slurries comprised of particles and process water, that are present in aggregate, minerals, coal and frac sand wet processing applications.

A number of chemical engineering unit operations have been developed in the past to deal with water removal. Wet classification is a process of separating particles in a feed material depending on their settling rates in a fluid. Larger, heavier sized particles sink to the bottom, while smaller, lighter fractions float to the top and overflow weirs on the equipment. Centrifugation can dewater materials by centrifugal force that draws particles away from the center of rotation. Filtration can remove water and other liquids from slurries by forcing the liquid through a permeable barrier or filter media and leave a trapped cake of drier solids that are too large to pass through the barrier or filter media. Dewatering through filtration creates dry material as well as reusable process water.

These approaches can be complex and in some cases labor intensive.

### BRIEF DESCRIPTION OF THE DRAWINGS

FIG. 1 illustrates an overall view of an embodiment of this disclosure utilizing an elongated tube mounted within a parabolic solar trough with a slurry fill on the left end and a waste drop on the other end of the elongated tube.

FIG. 2 illustrates some of the internals of the elongated tube of FIG. 1, including a mechanically powered augur within the elongated tube that conveys the slurry through the elongated tube where it is heated by solar impingement, volatilizing the liquid in the slurry as it is being conveyed from the slurry fill end to the waste drop end. The volatilized liquid passing through is returned via an internal hollow pipe back through the augur where it is released with all solids removed.

FIG. 3 is a more detailed view of the waste end of the elongated tube illustrating a long auger waste discharge from the system.

FIG. 4 is another view of the long augur waste discharge illustrating the internal auger.

FIG. 5 illustrates an overall view of an alternate embodiment of this disclosure utilizing an elongated tube mounted within a parabolic solar trough with a slurry fill on the far end and a waste drop on the near end of the elongated tube.

FIG. 6 illustrates the same system as FIG. 5 viewed from the other end to better illustrate some of the details of the slurry fill.

FIG. 7 is a more detailed view of the elongated tube illustrating a mechanically powered augur within the elongated tube that conveys the slurry through the elongated tube where it is heated by solar impingement, volatilizing the liquid in the slurry as it is being conveyed from the slurry fill end to the waste drop end.

FIG. 8 is a more detailed view of a long augur waste discharge tube where the solids are removed and illustrates another mechanically powered internal auger within the waste discharge tube.

### BRIEF SUMMARY

This disclosure describes a solar powered device for efficient removal of volatile liquids from industrial solid-liquid slurries including at least: a screw conveyor inside an elongated tube, with the conveying flights of the screw conveyor mounted onto a hollow pipe within the elongated tube; a first end of the elongated tube comprising a feed port for a solid-liquid slurry; a second end of the elongated tube comprising a waste drop for removal of the solids material after its liquids have been removed; wherein the elongated tube is centered in a parabolic solar trough that impinges solar energy onto the elongated tube to volatilize the volatile liquid from the contained slurry; wherein the elongated tube is not perfectly round but is topped with an enclosed vertical U-shaped or V-shaped top that provides a pathway for the volatile vapor removed from the solid-liquid slurry; and wherein the hollow pipe that recycles the volatile vapor removed from the solid-liquid slurry counter-currently back through the hollow pipe within the elongated tube removes the resulting liquid. Furthermore, the solids removed through the waste drop from the elongated tube pass through a long auger discharge where they are conveyed by an internal screw conveyor and finally exist the overall device through a final waste drop.

The disclosure also describes a method for utilizing solar power for efficient removal of volatile materials such as water from industrial slurries including at least: providing a screw conveyor or auger inside an elongated tube, with the conveying flights of the screw conveyor mounted onto a hollow pipe within the elongated tube; providing a first end of the elongated tube with a feed port for a solid-liquid slurry; providing a second end of the elongated tube with a waste end for removal of solids material; positioning the elongated tube in a parabolic solar trough that impinges solar energy onto the elongated tube to volatilize the volatile liquid from the contained slurry; providing an enclosed vertical U shaped top to the elongated tube that provides a pathway for the volatile vapor removed from the solid-liquid slurry; providing a vacuum at the first end of the elongated tube to drive the flow of volatized vapor in a counter-current flow in the hollow pipe of the elongated tube; providing an exit from the hollow pipe of the elongated tube for removing the liquid of the solid-liquid slurry. Furthermore the method provides for feeding the solids from the waste drop from the elongated tube pass through a long auger discharge where they are conveyed by an internal screw conveyor and finally exist the overall device through a final waste drop.

This disclosure further describes a solar powered device with a first end and a second end for efficient removal of volatile liquids from industrial solid-liquid slurries including at least: a solid-liquid slurry fill tank and a feed tube with an internal powered auger that feeds the solid-liquid slurry upward into an elongated tube including at least: a screw conveyor or auger inside the elongated tube; a first end of the elongated tube including at least a feed port for a solid-liquid slurry; a second end of the elongated tube including at least a waste drop for removal of the solids material from the elongated tube after its liquids have been removed; wherein the elongated tube is centered in a parabolic solar trough that impinges solar energy onto the elongated tube to volatilize the volatile liquid from the contained slurry into a vapor; wherein the elongated tube is not perfectly round but is topped with an enclosed vapor chamber that provides a pathway for the volatile vapor removed from the solid-liquid slurry as the slurry travels through the elongated tube; wherein the first end of the solar powered device also includes at least a vacuum system including at least a vacuum pump connected to a distillate tank that collects the distillate removed from the slurry and gives the volatile vapor removed from the slurry a flow direction toward the first end of the solar powered device while lowering the boiling point of the liquid in the slurry; and wherein the solids removed through the waste drop from the second end of the elongated tube pass through a long auger discharge where they are conveyed by an internal screw conveyor and finally exist the overall device through a final waste drop.

The disclosure also describes a method for utilizing solar power for efficient removal of volatile materials such as water from industrial slurries including at least: providing a solid-liquid slurry fill tank and a feed tube with an internal powered auger that feeds the solid-liquid slurry upward into an elongated tube including at least: a screw conveyor or auger inside the elongated tube; providing a first end of the elongated tube including at least a feed port for a solid-liquid slurry; providing a second end of the elongated tube including at least a waste drop for removal of the solids material from the elongated tube after its liquids have been removed; wherein the elongated tube is centered in a parabolic solar trough that impinges solar energy onto the elongated tube to volatilize the volatile liquid from the contained slurry into a vapor; providing an enclosed vapor chamber over the top of the elongated tube that provides a pathway for the volatile vapor removed from the solid-liquid slurry as the slurry travels through the elongated tube; providing on the first end of the solar powered device a vacuum system including at least a vacuum pump connected to a distillate tank that collects the distillate removed from the slurry and gives the volatile vapor removed from the slurry a flow direction toward the first end of the solar powered device while lowering the boiling point of the liquid in the slurry; and providing for the solids removed through the waste drop from the second end of the elongated tube pass through a long auger discharge where they are conveyed by an internal screw conveyor and finally exist the overall device through a final waste drop.

### DETAILED DESCRIPTION

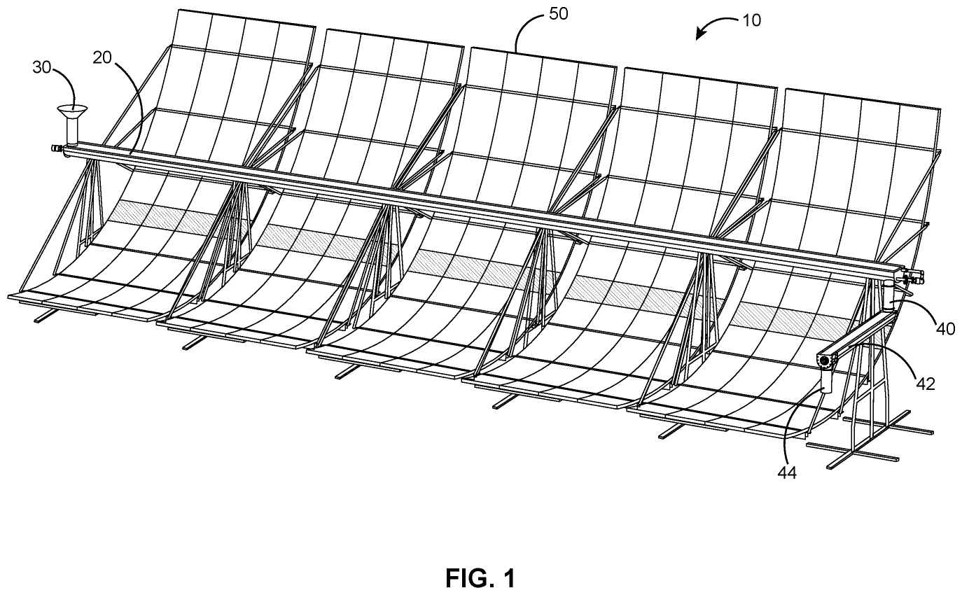

Referring now to FIG. 1 and shown generally as numeral 10 is an elongated tube 20 mounted within a parabolic solar trough 50 with a slurry fill 30 on a first end and a waste drop 40 on a second end of the elongated tube. In a given installation in a particular application there could be one such elongated tube and for larger applications there could be multiple of these tubes aligned within multiple solar troughs. In use a solid-liquid slurry containing a volatile material is fed on the left end of elongated tube 20 through slurry fill opening 30 and travels down the elongated tube 20 and is heated by solar impingement from the parabolic solar trough 50. The waste drop 40 feeds into a long auger discharge 42 and eventually discharges from the system at waste drop 44. The long auger discharge is described in following Figures.

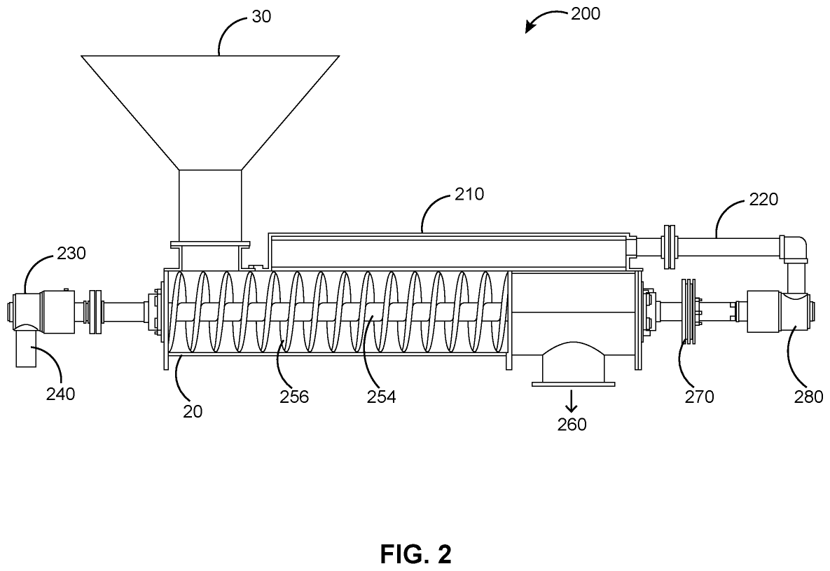

FIG. 2, shown generally as numeral 200 is now focused on the internal and external aspects of the elongated tube shown as 20 in FIG. 1. The elongated tube is hollow and can be of elongated length but is shown in a compressed form in FIG. 2 for illustration purposes. The slurry fill 30 is shown at a first end of the hollow elongated tube and comprises a screw conveyor (augur) 256 within the elongated tube that serves to convey the slurry down the hollow elongated tube 20 toward a waste discharge 260 at the other end. The waste discharge 260 feeds into the waste drop 40 of FIG. 1.

As the slurry is being conveyed the hollow elongated tube 20 is heated by solar impingement from the parabolic solar trough, volatilizing the liquid in the slurry as it is being conveyed from the slurry fill end to the waste discharge end. The elongated tube 20 is not completely round in that it has an enclosed vertical U-shaped or V-shaped “hen house” top 210 along the top. As the liquid is being volatilized from the slurry while traveling down the elongated tube 20 the volatile liquid (steam in the case of water) it is collected overhead in the “Hen House” or vertical structure 210 on top. This vapor is redirected back counter-currently via pipe 220 and is returned through a hollow pipe 254 that is internal to the screw conveyor or auger 256, thus releasing its heat of vaporization as it condenses back within the hollow pipe 254 via heat conduction, creating a multi-effect/multi-flash system before the resulting removed volatile liquid is removed from the system at the far end through pipe 240.

A vacuum (not shown) is applied at the first end 230 of the system to give the volatile vapor a flow direction and to lower the boiling point of the liquid. Although not shown in the figures, maintenance of the vacuum is aided by a controller that controls the level of slurry in the slurry fill 30 as the system runs.

The conveying flights of the screw conveyor 256 are mounted on the hollow pipe 254 that also serves to pass recycled volatiles back toward the slurry feed entrance in a counter-current flow to exchange heat via heat conduction through hollow pipe 254 with the entering slurry.

As shown previously in FIG. 1 the entire apparatus described above is centered in a parabolic trough which is heated through solar impingement and multiple elongated tubes could be centered in multiple parabolic troughs of varying lengths dependent on the application.

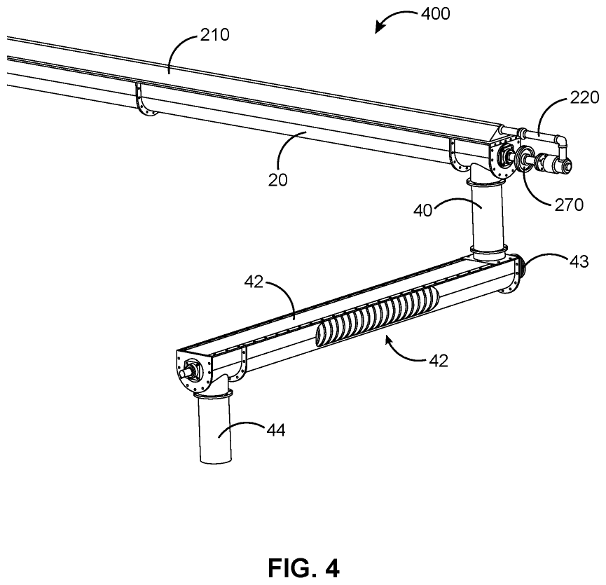

The process is controlled by the screw conveyor speed. So that, if one wants to dry the material more, the screw conveyor speed is less, or if the desire is to remove less liquids, the screw speed is increased. The screw conveyor speed is controlled by a chain driven sprocket wheel 270 (FIGS. 2 and 4).

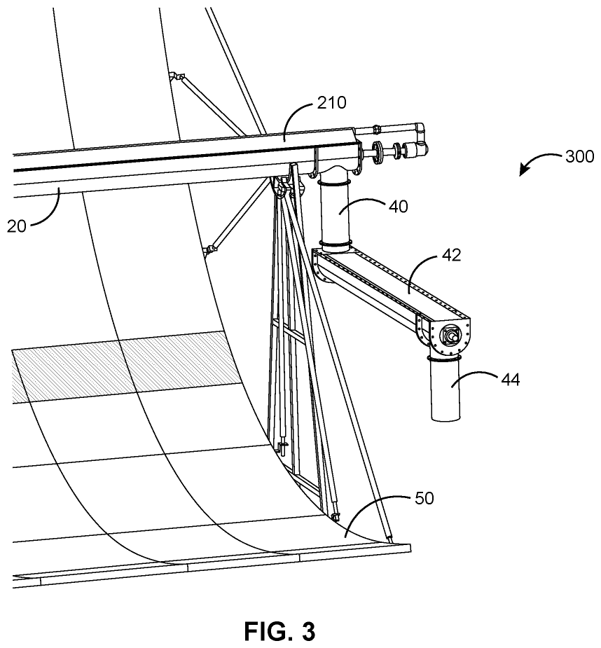

FIG. 3, shown generally as 300 illustrates in more detail how the solids with volatiles removed exit the elongated tube 20 down waste drop 40. These solids enter a long auger discharge 42 where they are conveyed by an internal screw conveyor (auger) system before finally exiting the system as solids through waste drop 44. As discussed earlier in FIG. 2 a vacuum (not shown) is applied at the first end of the elongated tube to give the vapor a flow direction and to lower the boiling point of the liquid. Proper control of that vacuum requires that the two “openings” in the system (the slurry fill 30 and the waste drop 44) are not truly open during operation. As described in FIG. 2 with respect to slurry fill 30 maintenance of the vacuum is aided by controlling the level of slurry in the slurry fill system as the system runs to maintain a seal of solid-liquid slurry within the slurry fill system. With the final waste drop 44 the vacuum seal is maintained by keeping the long auger discharge 42 always filled with solids by a controller that controls the auger speed.

FIG. 4, shown generally as 400 illustrates this further by showing that the long auger discharge 42 has an internal screw conveyor (auger) illustrated by showing part of the wall of the long auger discharge 42 with a transparent wall 41 exhibiting the internal auger within long auger discharge 42. The speed of the auger system can be mechanically chain driven by a sprocket wheel 43 and the speed of that augur is controlled to maintain a full long auger discharge 42, thus maintaining the vacuum.

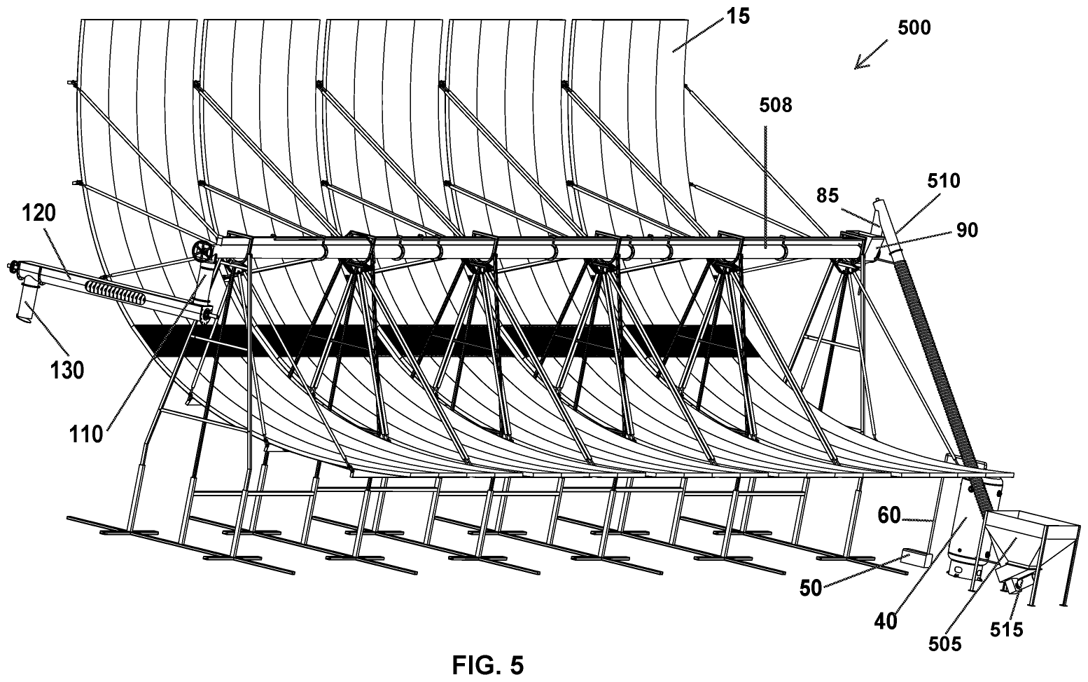

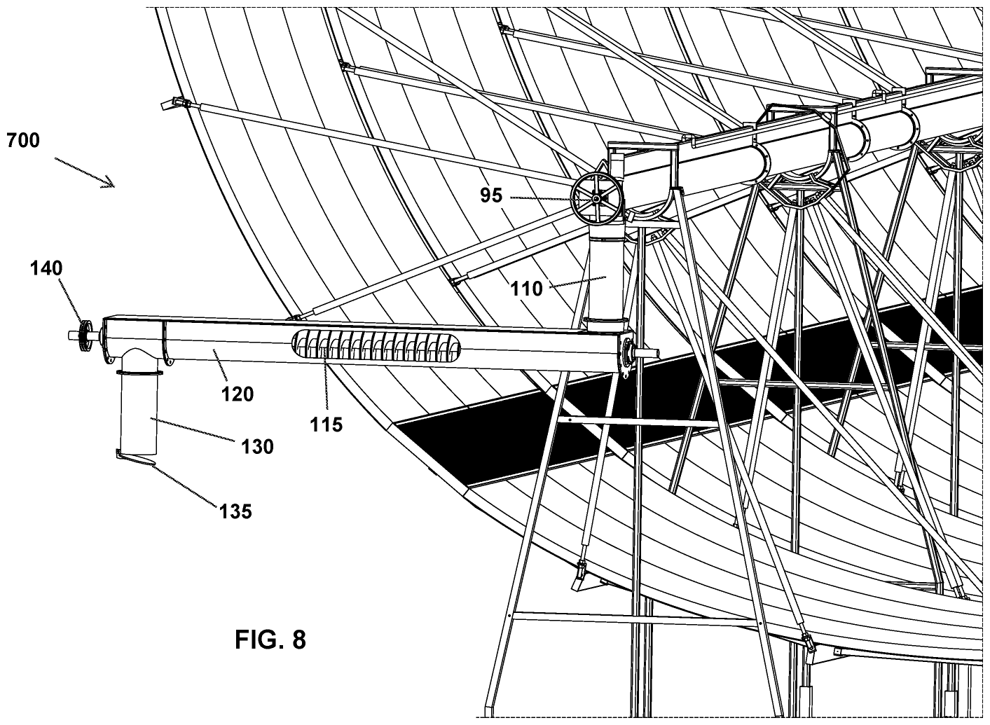

Referring now to FIG. 5 and shown generally as numeral 500 is an alternate solar powered device with a first end and second end and an elongated tube 508 mounted within a parabolic solar trough 15 with a slurry fill port 505 on the first end and a first waste drop 110 on a second end of the elongated tube 508. Waste drop 110 feeds into a long auger discharge 120 and eventually discharges from the system at waste drop 130. The long auger discharge is described in in more detail in FIG. 8

In a given particular application there could be one such elongated tube and for larger applications there could be multiple of these tubes aligned within multiple solar troughs.

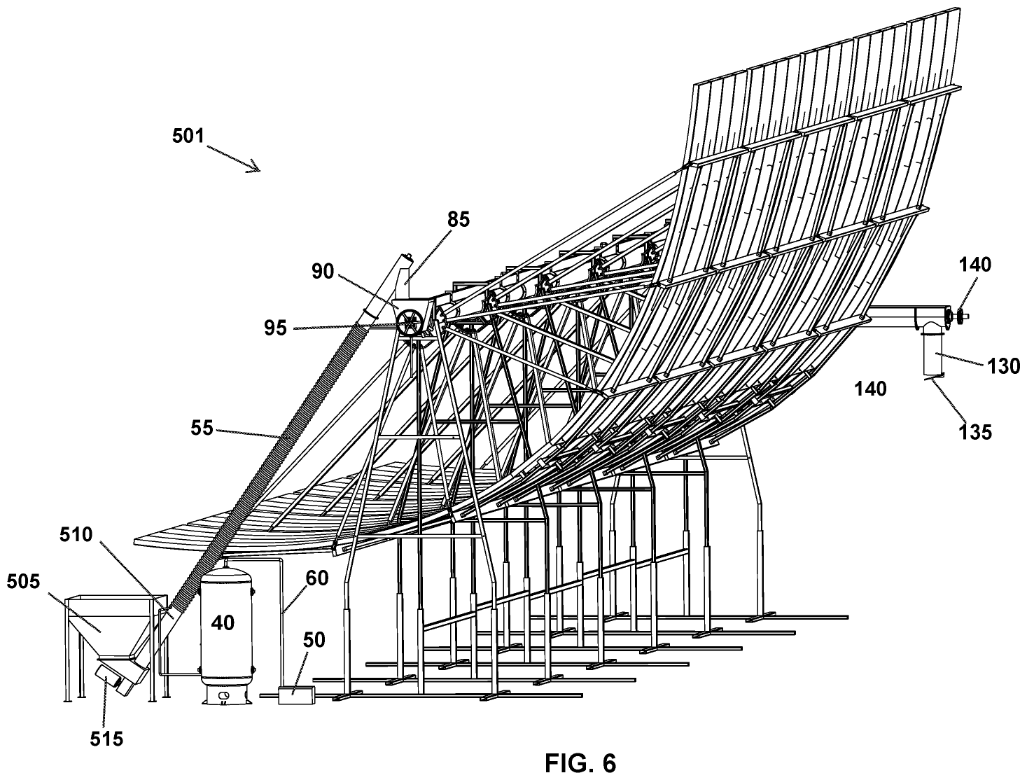

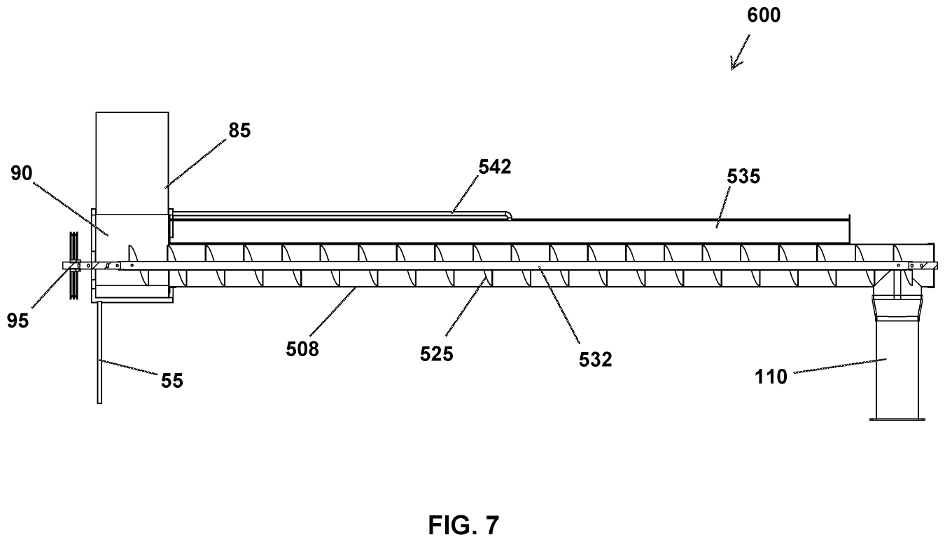

Turning now to FIG. 6 (shown generally as 501), which is looking at the system of FIG. 5 from the opposite end we see that in-use a solid-liquid slurry containing a volatile material is fed into the system into the top opening of slurry fill port 505 and the wet slurry is then carried up through feed tube 510 via an internal auger (screw conveyor—not shown) driven by motor 515. The wet slurry is fed to the top of tube 510 and drops down via drop 85 into the feed section 90 of elongated tube 508 (visible in FIG. 5). Sprocket 95 can be a chain driven sprocket wheel that drives the speed of screw conveyor 25 (shown in FIG. 7) to move the wet slurry through elongated tube 508 and toward the far end of the elongated tube. As the slurry travels down the elongated tube 508 it is heated by solar impingement from the parabolic solar trough 15, driving the volatile liquids from the solids. Waste drop 110 (FIG. 5) feeds into the long auger discharge 120 and eventually discharges from the system at waste drop 130. The long auger discharge is described in FIG. 8.

Still looking at FIG. 6 a vacuum pump 50 is shown, which keeps the entire system under vacuum by pulling a vacuum on the top end of condensate tank 40. A condensate coil 55 from the bottom of condensate tank 40 is then coiled completely around feed tube 510 over most of its length.

FIG. 7, shown generally as numeral 600 is now focused on the internal and external aspects of the elongated tube shown as 508 in FIG. 5. The elongated tube is hollow and can be of elongated length but is shown in a compressed form in FIG. 7 for illustration purposes. The wet slurry from slurry fill port 505 (FIG. 6) that is fed up tube 510 (FIG. 6) is dropped via drop 85 into feed section 90 shown at a first end of the hollow elongated tube 508 and comprises a screw conveyor (augur) 525 within elongated tube 508 that serves to convey the slurry down the elongated tube 508 toward a first waste drop 110 at the other end. This waste drop 110 drops solids into the long auger discharge 120 which will be described more completely in FIG. 8.

As the slurry is being conveyed through the hollow elongated tube 508 it is heated by solar impingement from the parabolic solar trough 15 (FIG. 5), volatilizing the liquid in the slurry as it is being conveyed from the slurry fill end to the waste discharge end. The elongated tube 508 is not completely round in that it has an enclosed vapor chamber 535 along the top. As the liquid is being volatilized from the slurry while traveling down the elongated tube 508 the volatile vapor (steam in the case of water) it is collected overhead in this enclosed vapor structure 535. This hot vapor is pulled via the vacuum on line 542 which is connected to a double lined feed section 90 at the first end of the hollow elongated tube 508. The condensate coil 55, which is the coil that is wrapped around the feed tube 510 of FIG. 6 is connected near the bottom of feed tube 510 to distillate tank 40 which is under the overall system vacuum provided by vacuum pump 50 and collects the distillate liquid removed from the wet slurry. The vacuum draw from condensate coil 55 thus directs the hot vapor created by the solar impingement of the elongated tube 508 into direct contact via heat conduction with both the double-lined feed section 90 and the feed tube 510 (FIG. 6) to exchange the distillate heat derived from parabolic solar trough 15 into the incoming wet slurry materials, conserving energy.

The vacuum pump 50 is applied at the first end of the system to give the volatile vapor a flow direction toward the first end of the system and to lower the boiling point of the liquid. Although not shown in the figures, maintenance of the vacuum is aided by a controller that controls the level of slurry in the slurry fill port 505 (FIG. 6) as the system runs.

The conveying flights of the screw conveyor 525 are mounted on a pipe 532 running through elongated tube 508.

As shown previously in FIG. 5 the entire apparatus described above is centered in a parabolic trough 15 which is heated through solar impingement and multiple elongated tubes could be centered in multiple parabolic troughs of varying lengths dependent on the application.

The removal process is controlled by the screw conveyor speed of the screw conveyor 525 in the elongated tube 508. So that, if one wants to dry the material more, the screw conveyor speed is less, or if the desire is to remove less liquids, the screw speed is increased. The screw conveyor speed of the elongated tube 508 can be controlled by chain driven sprocket wheel 95.

FIG. 8, shown generally as 700 illustrates in more detail how the solids with volatiles removed exit the elongated tube 508 (FIG. 6) down waste drop 110. These solids enter a long auger discharge 120 where they are conveyed by an internal screw conveyor (auger) system before finally exiting the system as solids through waste drop 130. As discussed earlier in FIG. 6 a vacuum pump 50 is applied at the first end of the elongated tube to give the vapor a flow direction and to lower the boiling point of the liquid. Proper control of that vacuum requires that the two “openings” in the system (the slurry fill port 505 and the waste drop 44) are not truly open during operation. As described in FIG. 6 with respect to slurry fill port 505 maintenance of the vacuum is aided by controlling the level of slurry in the slurry fill system as the system runs to maintain a seal of solid-liquid slurry within the slurry fill port system. With the final waste drop 130 the vacuum seal is maintained by keeping the long auger discharge 120 always filled with solids by a controller that controls the auger speed.

FIG. 8 illustrates this further by showing that the long auger discharge 120 has an internal screw conveyor (auger) illustrated by showing part of the wall of the long auger discharge with a transparent wall 115 exhibiting the internal auger within long auger discharge 120. The speed of the auger system can be mechanically chain driven by a sprocket wheel 140 and the speed of that augur is controlled to maintain a full long auger discharge 120, thus maintaining the vacuum on the system. Of note, the vacuum flap 135 shown in FIG. 4 is set to the closed position before start-up and does not begin to open under computer control until a substantial amount of the solids fill long auger discharge 120, maintaining the vacuum.

The use of parabolic solar troughs has obvious advantages related to energy savings. It should be noted though that there are applications in which 24-hour power is needed and the concepts exemplified here could use other sources such as gas or electric heaters to heat the elongated tube when solar impingement is not available. The system described would work in the same way in providing efficient removal of liquids from solid-liquid slurries.

This disclosure has been described with reference to specific details of particular embodiments. It is not intended that such detailed be regarded as limitations upon the scope of the invention except insofar as and to the extent that they are included in the eventual claims.

What we claim is:

1. A solar powered device with a first end and a second end for efficient removal of volatile liquids from industrial solid-liquid slurries comprising:
a. a solid-liquid slurry fill port and a feed tube with an internal powered auger that feeds the solid-liquid slurry upward into an elongated tube comprising: a screw conveyor or auger inside the elongated tube;
b. a first end of the elongated tube including at least a feed port for a solid- liquid slurry;
c. a second end of the elongated tube including at least a waste drop for removal of the solids material from the elongated tube after its liquids have been removed;
d. wherein the elongated tube is centered in a parabolic solar trough that impinges solar energy onto the elongated tube to volatilize the volatile liquid from the contained slurry into a vapor;
e. wherein the elongated tube is not perfectly round but is topped with an enclosed vapor chamber that provides a pathway for the volatile vapor removed from the solid-liquid slurry as the slurry travels through the elongated tube;
f. wherein the first end of the solar powered device also includes at least a vacuum system including at least a vacuum pump connected to a distillate tank that collects the distillate removed from the slurry and gives the volatile vapor removed from the slurry a flow direction toward the first end of the solar powered device while lowering the boiling point of the liquid in the slurry; and
g. wherein the solids removed through the waste drop from the second end of the elongated tube pass through a long auger discharge where they are conveyed by an internal screw conveyor and finally exist the overall device through a final waste drop.

2. The solar powered device with a first end and a second end for efficient removal of volatile liquids from industrial solid-liquid slurries of claim 1 wherein a controller that controls the level of slurry in the slurry fill feed port aids in maintaining the vacuum in the solar powered device.

3. The solar powered device with a first end and a second end for efficient removal of volatile liquids from industrial solid-liquid slurries of claim 1 wherein a controller maintains a vacuum seal in the device by control of the speed of the long auger discharge to keep the long auger filled with solids.

4. The solar powered device for efficient removal of volatile liquids from industrial solid-liquid slurries of claim 1 wherein in a particular application there could be one such elongated tube and for larger applications there could be multiple of these tubes aligned within multiple solar troughs.

5. The solar powered device for efficient removal of volatile liquids from industrial solid-liquid slurries of claim 1 further comprising the addition of gas or electric heaters to heat the elongated tube to achieve 24-hour power in the absence of solar impingement.

6. A method for utilizing solar power for efficient removal of volatile materials such as water from industrial slurries comprising:
a. providing a solid-liquid slurry fill port and a feed tube with an internal powered auger that feeds the solid-liquid slurry upward into an elongated tube and further comprising:
b. providing a screw conveyor or auger inside the elongated tube;
c. providing a first end of the elongated tube including at least a feed port for a solid-liquid slurry;
d. providing a second end of the elongated tube comprising a waste drop for removal of the solids material from the elongated tube after its liquids have been removed;
e. wherein the elongated tube is centered in a parabolic solar trough that impinges solar energy onto the elongated tube to volatilize the volatile liquid from the contained slurry into a vapor;
f. providing an enclosed vapor chamber over the top of the elongated tube that provides a pathway for the volatile vapor removed from the solid-liquid slurry as the slurry travels through the elongated tube;
g. providing on the first end of the solar powered device a vacuum system including at least a vacuum pump connected to a distillate tank that collects the distillate removed from the slurry and gives the volatile vapor removed from the slurry a flow direction toward the first end of the solar powered device while lowering the boiling point of the liquid in the slurry; and
h. providing for the solids removed through the waste drop from the second end of the elongated tube pass through a long auger discharge where they are conveyed by an internal screw conveyor and finally exist the overall device through a final waste drop.

7. The method for utilizing solar power for efficient removal of volatile materials such as water from industrial slurries of claim 6 further comprising a controller that controls the level of slurry in the slurry fill feed port that aids in maintaining the vacuum in the solar powered device.

8. The method for utilizing solar power for efficient removal of volatile materials such as water from industrial slurries of claim 6 further comprising providing a controller that maintains a vacuum seal in the method by controlling of the speed of the long auger discharge to keep the long auger filled with solids.

9. The method for utilizing solar power for efficient removal of volatile materials such as water from industrial slurries of claim 6 further comprising providing wherein one such elongated tube in a particular application and for larger applications there could be multiple of these tubes aligned within multiple solar troughs.

10. The method for utilizing solar power for efficient removal of volatile materials such as water from industrial slurries of claim 6 further comprising providing the addition of gas or electric heaters to heat the elongated tube to achieve 24-hour power in the absence of solar impingement.
